(19) United States
(12) Patent Application Publication
(10) Pub. No.: US 2013/0032630 A1
(43) Pub. Date: Feb. 7, 2013

(54) FRICTION STIR WELDING REPAIRING METHOD OF METALLIC HOUSING

(71) Applicants: WEI-TING WANG, Tu-Cheng (TW); CHUN-LANG LEE, Tu-Cheng (TW); YU-WEN CHIU, Tu-Cheng (TW)

(72) Inventors: WEI-TING WANG, Tu-Cheng (TW); CHUN-LANG LEE, Tu-Cheng (TW); YU-WEN CHIU, Tu-Cheng (TW)

(73) Assignee: HON HAI PRECISION INDUSTRY CO., LTD., Tu-Cheng (TW)

(21) Appl. No.: 13/316,722

(22) Filed: Dec. 12, 2011

(30) Foreign Application Priority Data
Aug. 5, 2011 (CN) 201110223577.5

(51) Int. Cl. B23K 20/12

(52) U.S. Cl. 228/112.1

(57) ABSTRACT

A friction stir welding repairing method for repairing a defective welding area, in which the defective welding area is defined in a predetermined welding area of a metallic housing, is described as follows. A repairing welding tool has a main portion and a stir end extending from an end of the main portion, and a diameter of the stir end is larger than a diameter of the defective welding area. The repairing welding tool is rotated and inserted to a region of the predetermined welding area adjacent to the defective welding area. The repairing welding tool is rotated and moved across the defective welding area. The repairing welding tool is pulled out of the predetermined welding area, and then the defective welding area is cooled.

### BACKGROUND

1. Technical Field

The present disclosure generally relates to friction stir welding repairing methods, and particularly, to a friction stir welding repairing method for a metallic housing.

2. Description of the Related Art

Friction stir welding is widely used to join aluminum alloy because it is simple to perform.

A metal structure of the stirred product can be uneven in consistency, since the material of the stirred portion of the product plastically flows during the friction stir welding process. After treatment, the different areas, specifically the stirred and unstirred portions of the product, may exhibit different textures. The joining portion of between the workpieces provides an unfavorable appearance. Despite product annealing, the difference in appearance of the joined portion persists. Therefore, this cannot satisfy a product with the stirred surface presented as an outer surface. Achievement of a favorable appearance in products obtained by friction stir welding remains a challenge.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of a metallic housing made by an embodiment of a friction stir welding method.

FIG. 2 is a flowchart of the friction stir welding method of the embodiment.

FIG. 3 is an isometric view of a metallic housing having a defective welding area repaired by a repairing welding tool.

FIG. 4 is an isometric view of the repairing welding tool of FIG. 3.

FIG. 5 is a flowchart of a friction stir welding repairing method.

FIG. 6 is a schematic view showing a moving path of the repairing welding tool of FIG. 3.

FIG. 7 is an isometric view of the metallic housing of FIG. 3 after repairing is performed.

### DETAILED DESCRIPTION

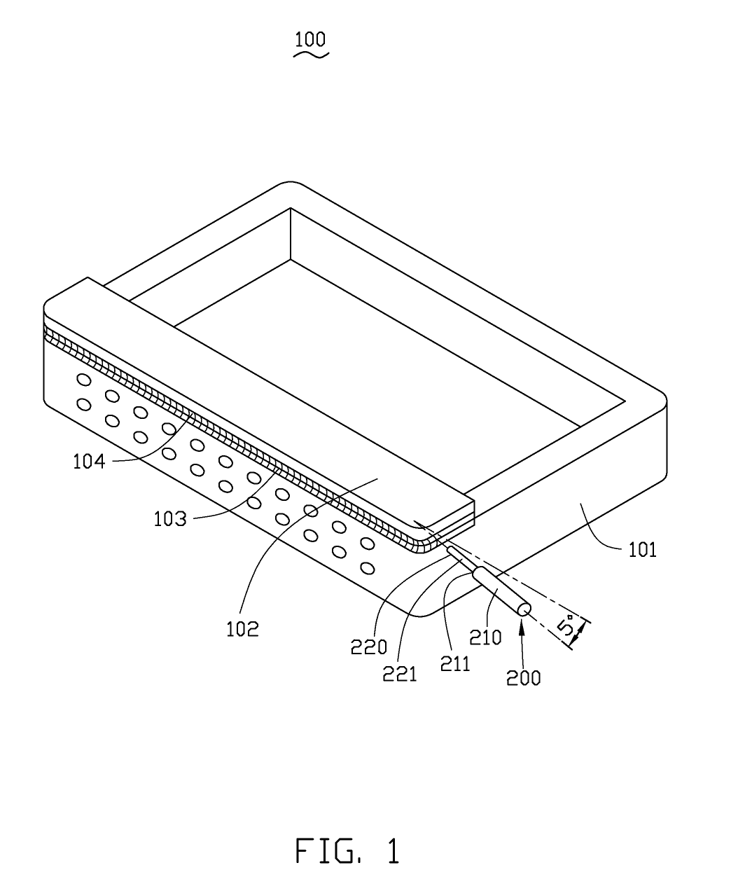

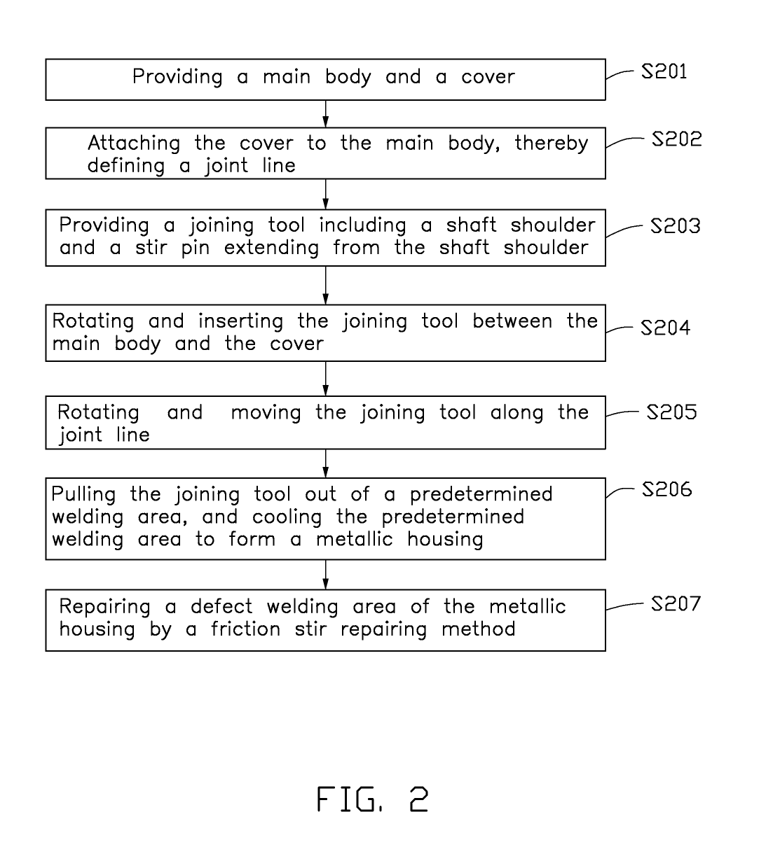

Referring to FIGS. 1 and 2, an embodiment of a friction stir welding method of manufacturing a metallic housing 100 is described as follow. In step S201, a main body 101 and a cover 102 is provided. In an illustrated embodiment, the main body 101 and the cover 102 are made of aluminum (Al) alloy.

In step S202, the cover 102 is attached to the main body 101, thereby defining a joint line 103 therebetween. In the illustrate embodiment, the joint line 103 is defined at one side of the cover 102 and the main body 101. A predetermined welding area 104 is defined by the main body 101 and the cover 102 extending along the joint line 103. The predetermined welding area 104 is strip-shaped.

In step S203, a joining tool 200 is provided. The joining tool 200 includes a shaft shoulder 210 and a stir pin 220 extending from a friction surface 211 of the shaft shoulder 210. The stir pin 220 is aligned with the shaft shoulder 210 at the central axis in an imaginary straight line. A diameter of the stir pin 220 is smaller than that of the shaft shoulder 210. The stir pin 220 is a non-consumable stir pin utilized in the friction stir welding process, and has a cylindrical friction surface 221.

In step S204, the joining tool 200 is rotated and inserted between the main body 101 and the cover 102. In the friction stir welding process, the stir pin 220 is rotated and vertically inserted between the main body 101 and the cover 102, until the friction surface 211 of the shaft shoulder 210 extends slightly into the predetermined welding area 104. The joining tool 200 rotates at a relatively high speed, and is inserted between the main body 101 and the cover 102 at a relatively low speed. Therefore, the main body 101 and the cover 102 are plasticized and joined together by rotating the joining tool 200. For example, the joining tool 200 may rotate at a speed from about 2700 r/min to 3000 r/min, and inserts between the main body 101 and the cover 102 at a speed from about 20 mm/min to about 40 mm/min. In the illustrated embodiment, the joining tool 200 rotates at a speed of about 2800 r/min, and inserts between the main body 101 and the cover 102 at a speed of about 30 mm/min.

In step S205, the joining tool 200 rotates along the axis thereof relative to the main body 101 and the cover 102 and moves along the joint line 103. Therefore, the cylindrical friction surface 221 of the stir pin 220 rubs the main body 101 and the cover 102, and the friction surface 211 of the shaft shoulder 210 rubs the predetermined welding area 104. Thus, the joining tool 200 produces a local region of highly plasticized material such that the main body 101 and the cover 102 diffuse amongst each other. As such, the main body 101 and the cover 102 are joined. The joining tool 200 may move along the joint line 103 at a speed from about 40 mm/min to about 600 mm/min, and in the present embodiment, the joining tool 200 moves along the joint line 103 at a speed from about 100 mm/min, in which a rotation axis of the joining tool 200 deviates from a direction perpendicular to the predetermined welding area 104 at about 5 degrees or about 6 degrees.

In step S206, the joining tool 200 is drawn or taken out of the predetermined welding area 104, and then the predetermined welding area 104 is cooled to form the metallic housing 100. The predetermined welding area 104 may be cooled by water or wind, or by positioning in the air for a certain time.

After the step S206, the metallic housing 100 may generate a defective welding area 105. When the joining tool 200 is drawn out of the predetermined welding area 104, a hole is remained in the predetermined welding area 104, and may be not filled with the plasticized metal material; therefore, the defective welding area 105 is generated. In the illustrated embodiment, the defective welding area 105 is a circular hole.

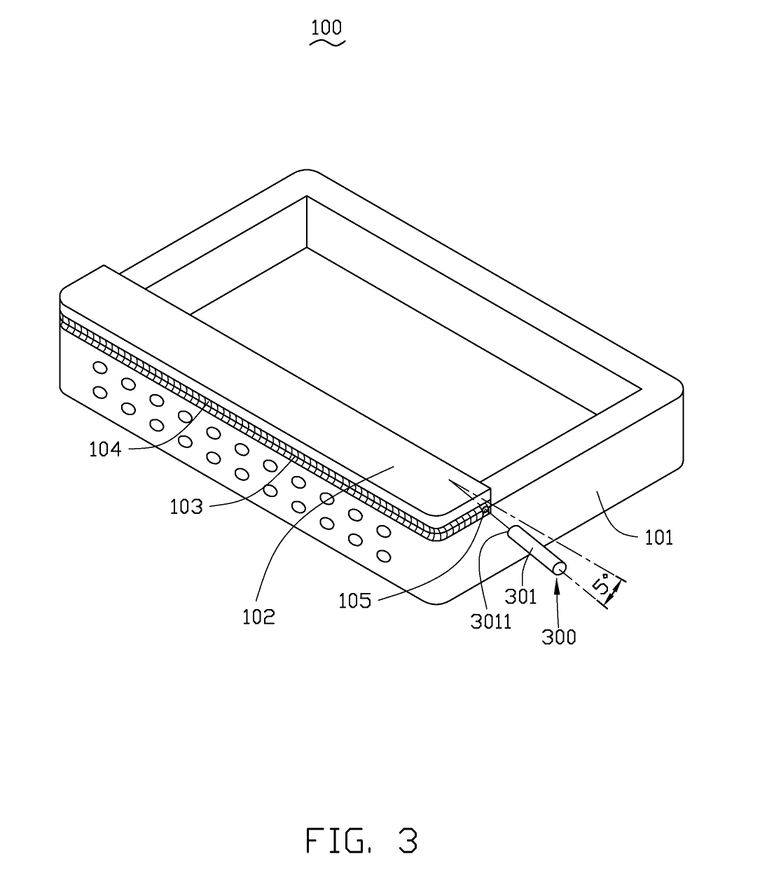

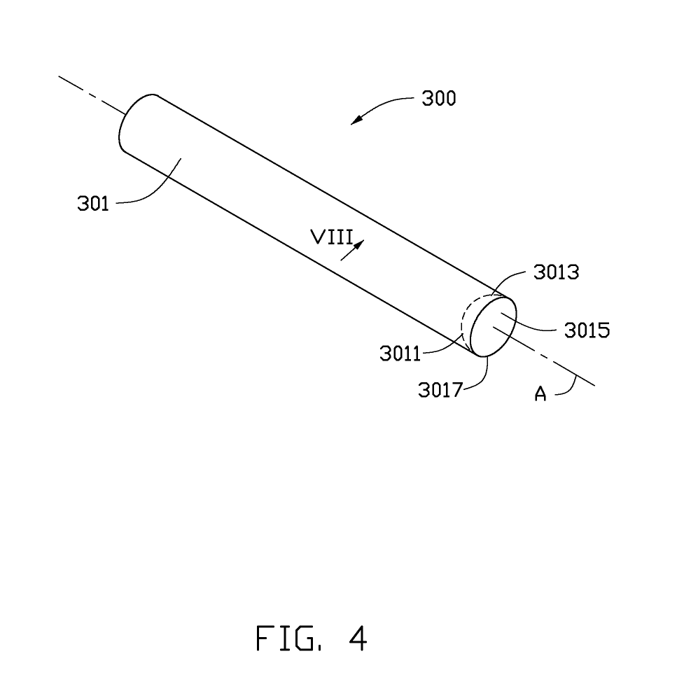

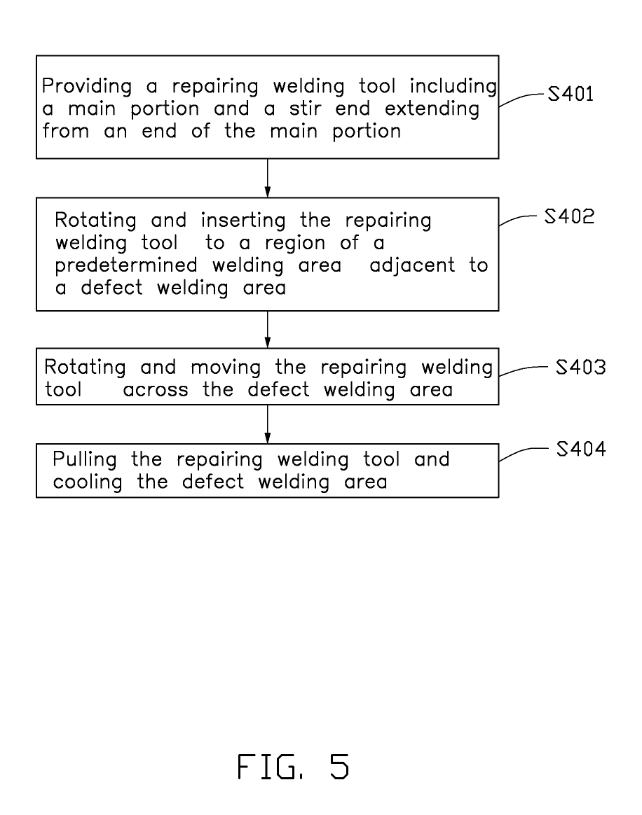

In step S207, the defective welding area 105 is repaired by a friction stir welding repairing method. Referring to FIGS. 3 through 5, the friction stir welding repairing method is described in details as following.

In step S401 of the friction stir welding repairing method, a repairing welding tool 300 includes a main portion 301 and a stir end 3011 extending from an end of the main portion 301. A diameter of the stir end 3011 is larger than that of the defective welding area 105. In the illustrated embodiment, the main portion 301 and the stir end 3011 are cylindrical. The stir end 3011 has a cylindrical surface 3013 and a concave end surface 3015 connecting to the cylindrical surface 3011. An annular blade 3017 is formed at a connecting portion of the cylindrical surface 3013 and the concave end surface 3015. A depth of the concave end surface 3015 may be from about 0.5 mm to about 1 mm. The concave end surface 3015 may be a spherical surface.

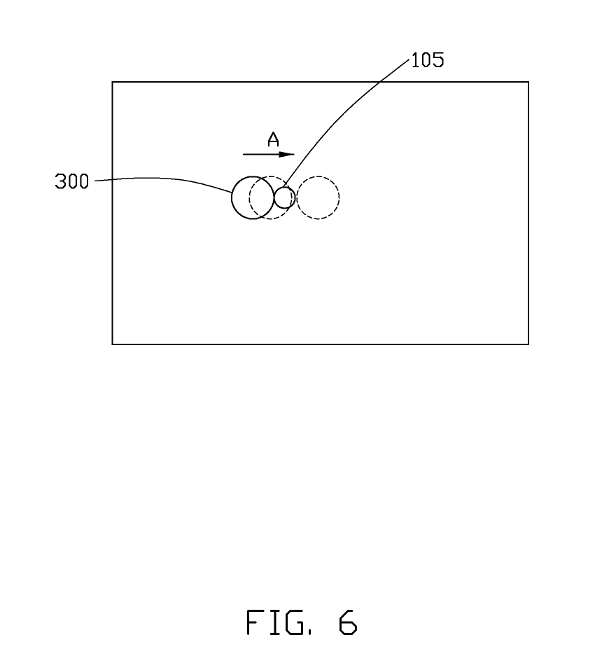

In step S402 of the friction stir welding repairing method, the repairing welding tool 300 is rotated and inserted to a region of the predetermined welding area 104 adjacent to the defective welding area 105, in which the stir end 3011 is substantially at an angle tangent to the defective welding area 105 (see FIG. 6). The repairing welding tool 300 may rotate at a speed from about 2000 r/min to 4000 r/min, and vertically inserts to the region adjacent to the defective welding area 105 at a speed from about 50 mm/min to about 200 mm/min. In the illustrated embodiment, the repairing welding tool 300 rotates at a speed of about 3000 r/min, and inserts to the region adjacent to the defective welding area 105 at a speed of about 100 mm/min. Therefore, the material in the defective welding area 105 are plasticized and joined together by rotating the repairing welding tool 300.

Referring to FIG. 6, in step S403 of the friction stir welding repairing method, the repairing welding tool 300 rotates along the axis thereof and moves across the defective welding area 105. A moving speed of the repairing welding tool 300 may be from 500 mm/min to 2000 mm/min. In the illustrated embodiment, the repairing welding tool 300 move linearly along an arrow A as shown in FIG. 6 at a speed of 600 mm/min. In an alternative embodiment, the rotating axis of the repairing welding tool 300 deviates from a direction perpendicular to the defective welding area 105 at 5 degrees.

In step S404 of the friction stir welding repairing method, the repairing welding tool 300 is pulled out of the metallic housing 100, and then the defective welding area 105 is cooled. The defective welding area 105 may be cooled by water or wind, or be positioned in the air for a certain time.

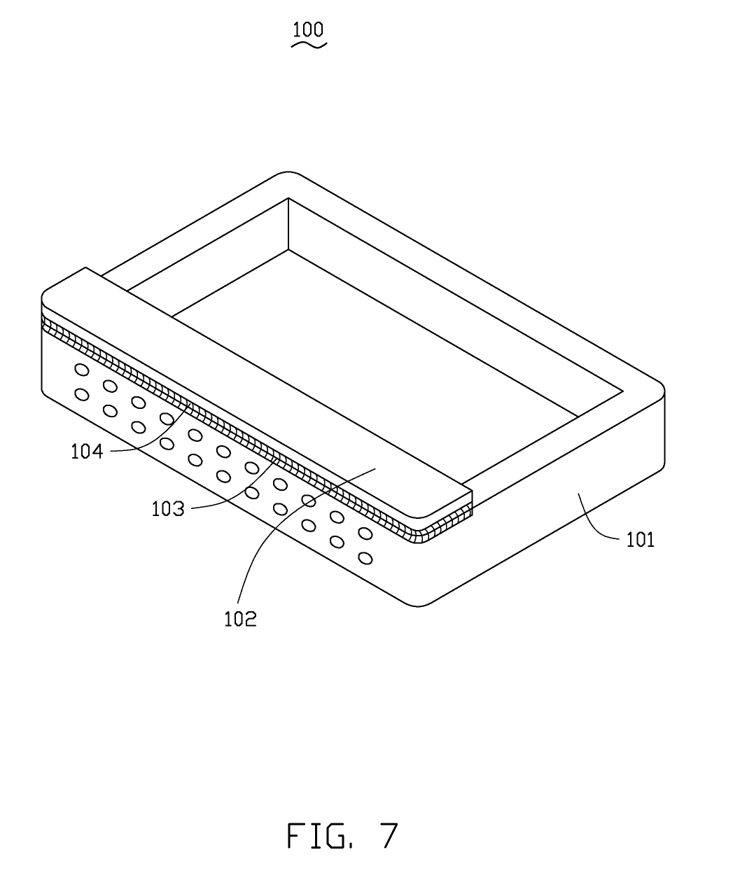

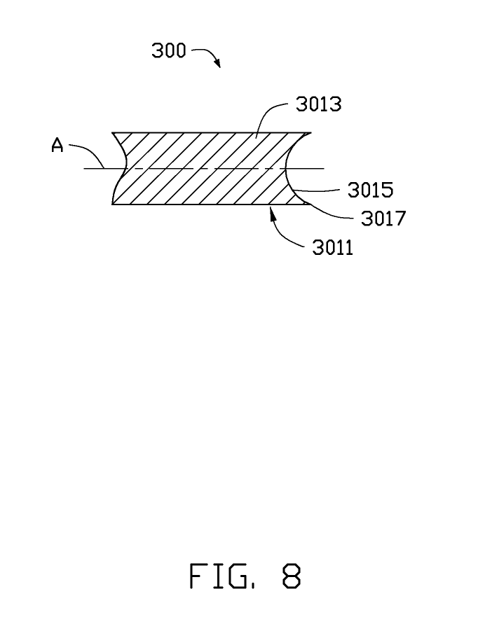

Referring to FIG. 7, after the step S404, the defective welding area 105 is removed from the metallic housing 100. It should be understood that, the stir end 3011 may be of other shapes, such as cuboid. In addition, the inserting point of the repairing welding tool 300 may be spaced from the defective welding area 105 for a certain distance.

Because the repairing welding tool 300 is substantially cylindrical, the repairing welding tool 300 is easily manufactured and correspondingly has a relatively low manufacturing cost. In addition, in the friction stir welding repairing process, the repairing welding tool 300 only need to move across the defective welding area 105 once, therefore, the repair efficiency is improved. Furthermore, because the rotating axis of the repairing welding tool 300 deviates from the direction perpendicular to the defective welding area 105 at 5 degrees, the plasticized material can be evenly driven to flatten the defective welding area 105, and thus the metallic housing 100 can have an attractive appearance.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

1. A friction stir welding repairing method for repairing a defective welding area, the defective welding area is defined in a predetermined welding area of a metallic housing, comprising:
providing a repairing welding tool having a main portion and a stir end extending from an end of the main portion, wherein the stir end has a cylindrical surface and a concave end surface connecting to the cylindrical surface, the concave end surface is a part of a spherical surface, in a cross-sectional plane taken along an axis line of the repairing welding tool, the cylindrical surface and the concave end surface cooperatively define a sharp acute angle, an annular blade is formed at a connecting portion of the cylindrical surface and the concave end surface, a diameter of the stir end is larger than a diameter of the defective welding area;
rotating and inserting the repairing welding tool to a region of the predetermined welding area adjacent to a defective welding area, wherein the defective welding area is a circular hole;
rotating and moving the repairing welding tool across the defective welding area; and
pulling the repairing welding tool out of the predetermined welding area and cooling the defective welding area.

2. (canceled)

3. The friction stir welding repairing method of claim 1, wherein the repairing welding tool is cylindrical.

4. The friction stir welding repairing method of claim 1, wherein a depth of the concave end surface is from about 0.5 mm to about 1 mm.

5. The friction stir welding repairing method of claim 1, wherein a rotating speed of the repairing welding tool is set from about 2000 r/min to about 4000 r/min

6. The friction stir welding repairing method of claim 5, wherein an inserting speed of the repairing welding tool is set from about 50 mm/min to about 200 mm/min.

7. The friction stir welding repairing method of claim 5, wherein a moving speed of the repairing welding tool across the defective welding area is set from about 500 mm/min to about 2000 mm/min.

8. The friction stir welding repairing method of claim 11, wherein after the repairing welding tool is rotated and inserted to the region of the predetermined welding area adjacent to the defective welding area, a cylindrical surface of the stir end abuts an edge of the defective welding area.

9. The friction stir welding repairing method of claim 1, wherein the metallic housing is made of aluminum alloy.

10. The friction stir welding repairing method of claim 1, wherein the rotating axis of the repairing welding tool deviates from a direction perpendicular to the defective welding area at about 5 degrees.

11. A friction stir welding method of manufacturing a metallic housing, comprising:
providing a main body and a cover, wherein the main body and the cover are made of metal;
attaching the cover to the main body, thereby defining a joint line;
providing a joining tool including a shaft shoulder and a stir pin extending from the shaft shoulder;
rotating and inserting the joining tool between the main body and the cover;
rotating and moving the joining tool along the joint line;
pulling the joining tool out of a predetermined welding area, and cooling the predetermined welding area to form the metallic housing having a defective welding area; and
repairing the defective welding area of the metallic housing produced by above-described friction stir welding method by a friction stir welding repairing method, the friction stir welding repairing method comprising:
providing a repairing welding tool having a main portion and a stir end extending from an end of the main portion, wherein a diameter of the stir end is larger than a diameter of the defective welding area;
rotating and inserting the repairing welding tool to a region of the predetermined welding area adjacent to a defective welding area, wherein the defective welding area is a circular hole;
rotating and moving the repairing welding tool across the defective welding area; and pulling the repairing welding tool out of the predetermined welding area and cooling the defective welding area.

12. The friction stir welding method of claim 11, wherein the stir end has a cylindrical surface and a concave end surface connecting to the cylindrical surface, and an annular blade is formed at a connecting portion of the cylindrical surface and the concave end surface.

13. The friction stir welding method of claim 12, wherein the repairing welding tool is cylindrical, and the concave end surface is a part of a spherical surface.

14. The friction stir welding method of claim 12, wherein a depth of the concave end surface is from about 0.5 mm to about 1 mm.

15. The friction stir welding method of claim 11, wherein a rotating speed of the repairing welding tool is set from about 2000 r/min to about 4000 r/min.

16. The friction stir welding method of claim 15, wherein an inserting speed of the repairing welding tool is set from about 50 mm/min to about 200 mm/min.

17. The friction stir welding method of claim 15, wherein a moving speed of the repairing welding tool across the defective welding area is set from about 500 mm/min to about 2000 mm/min.

18. The friction stir welding method of claim 11, wherein after the repairing welding tool is rotated and inserted to the region of the predetermined welding area adjacent to the defective welding area, a cylindrical surface of the stir end abuts an edge of the defective welding area.

19. The friction stir welding method of claim 11, wherein the joining tool comprises a shaft shoulder and a stir pin extending from a friction surface of the shaft shoulder, and a diameter of the stir pin is smaller than that of the shaft shoulder.

20. The friction stir welding method of claim 11, wherein the rotating axis of the repairing welding tool deviates from a direction perpendicular to the defective welding area at 5 degrees.
